(19) United States
(12) Patent Application Publication
(10) Pub. No.: US 2008/0310165 A1
(43) Pub. Date: Dec. 18, 2008

(54) Detachable Decorative Light Assembly

(76) Inventor: Xu-Liang Li, Dongguang (CN)

Correspondence Address: GLOBAL IP SERVICES, 7285 W. Eagle Court, Winton, CA, 95388, US

(21) Appl. No.: 12/034,938

(22) Filed: Feb. 21, 2008

(30) Foreign Application Priority Data
Jun. 18, 2007 (CN) 200720120773.9

(51) Int. Cl. F21S 13/14

(52) U.S. Cl. 362/252

(57) ABSTRACT

A detachable decorative light assembly includes at least one light strand, a main support frame configured for suspending the at least one light strand thereon, a sub-frame positioned on the main support frame and disposed around the upper portion of the main support frame and the at least one light strand; and a decorative outer coating configured for covering the sub-frame and the upper portion of the main support frame thereon. The main support frame includes an upper portion, a base portion, and an elastic member connected with the upper portion and the base portion. The decorative outer coating and the sub-frame swing from side to side together with the upper portion of the main support frame when the detachable decorative light assembly is exerted thereon.

### CROSS REFERENCE TO RELATED PATENT APPLICATION

This application claims the priority of the Chinese patent application No. 200720120773.9 with filing date of Jun. 18, 2007.

### BACKGROUND OF THE INVENTION

1. Technical Field

The present invention generally relates to a decorative light assembly, and more particularly, to a detachable decorative light assembly with a dynamic effect.

2. Description of the Related Art

It is extremely common for people to string light strands for festive occasions. The light strands are typically strung during the holiday periods (for example, Christmas) on buildings or Christmas trees to provide a festive atmosphere. Typically, the light strands have one or more wires that extend in a long strand with lights periodically spaced along the strand.

A conventional decorative light assembly includes a support frame, light strands positioned on the support frame, a decorative outer covering configured for covering the support frame and the light strands. The conventional decorative light assembly generally holds still, therefore, a dynamic effect is thus absent. As a result, the conventional decorative light assembly may not win the users' favour. Although a driving device with an electric motor is used to drive the conventional decorative light assembly to move from side to side, the cost is obviously increased. In addition, if the conventional decorative light assembly has been placed outside, the driving device is possible to be damaged by rain or snow. Further, the conventional decorative light assembly is difficult to be disassembled for storage so that a large room is occupied during nonuse. Hence it is not convenient to transport and ship the conventional decorative light assembly.

Therefore, what is needed is to provide a detachable decorative light assembly that has a dynamic effect and easy to be assembled and disassembled.

### SUMMARY OF THE INVENTION

A detachable decorative light assembly includes at least one light strand, a main support frame configured for suspending the at least one light strand thereon, a sub-frame positioned on the main support frame and disposed around the upper portion of the main support frame and the at least one light strand; and a decorative outer coating configured for covering the sub-frame and the upper portion of the main support frame thereon. The main support frame includes an upper portion, a base portion, and an elastic member connected with the upper portion and the base portion. The decorative outer coating and the sub-frame swing from side to side together with the upper portion of the main support frame when the detachable decorative light assembly is exerted thereon.

Other advantages and novel features will become more apparent from the following detailed description of embodiments when taken in conjunction with the accompanying drawings.

### BRIEF DESCRIPTION OF THE DRAWINGS

Many aspects of the present detachable decorative light assembly can be better understood with reference to the following drawings. The components in the drawings are not necessarily drawn to scale, the emphasis instead being placed upon clearly illustrating the principles of the present detachable decorative light assembly.

FIG. 1 is a perspective, phantom view of a detachable decorative light assembly in accordance with a preferred embodiment of the present invention, not shown a light strand;

FIG. 2 is a perspective view of a main support frame of the detachable decorative light assembly shown in FIG. 1, showing that a light strand is twisted around the main support frame;

FIG. 3 is an exploded, perspective view of the main support frame shown in FIG. 2;

FIG. 4 is a perspective view of a sub-frame of the detachable decorative light assembly shown in FIG. 1; and

FIG. 5 is a perspective view of a decorative outer coating of the detachable decorative light assembly shown in FIG. 1.

### DETAILED DESCRIPTION OF THE INVENTION

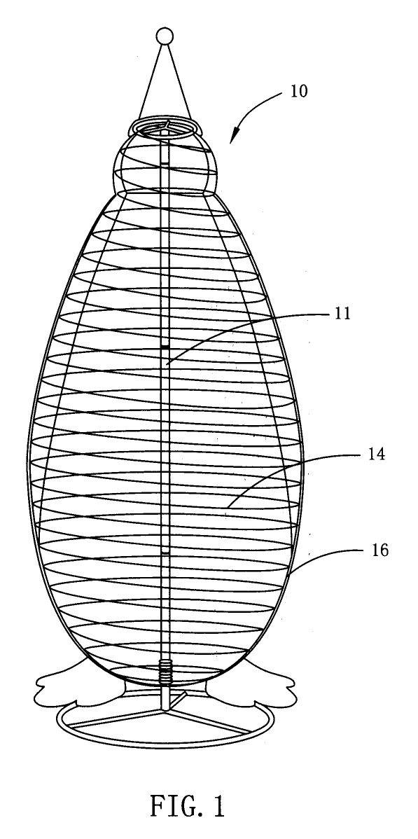

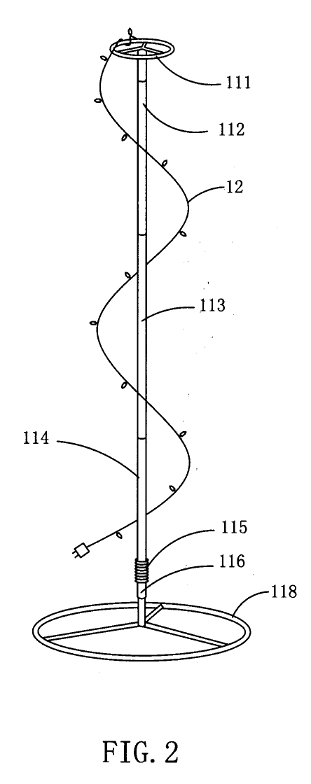

Referring to FIG. 1, a detachable decorative light assembly in accordance with a preferred embodiment of the present invention is provided. The detachable decorative light assembly 10 is a penguin in shape, and includes a main support frame 11, at least one light strand 12 (shown in FIG. 2) suspended from and coiled around the main support frame 11, a sub-frame 14 displaced around an upper end of the main support frame 11 and the light strand 12, and a decorative outer coating 16 configured for covering the sub-frame 14 and the upper end of the main support frame 11. The light strand 12 may be an LED (Light Emitting Diode) light strand, an LD (Laser Diode) light strand, or the like. Understandably, the detachable decorative light assembly 10 may be a snowman or a Santa Claus in shape.

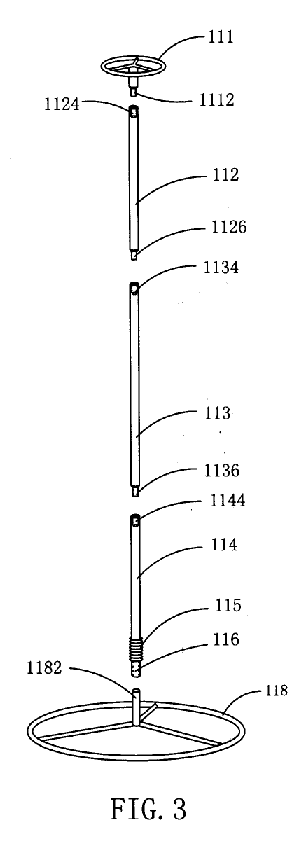

Referring to FIG. 2 and FIG. 3, the light strand 12 is suspended from the main support frame 11 and wrapped around the main support frame 11. In order to convenient transportation and shipment, the main support frame 11 generally includes an upper portion, a base portion, and an elastic member connected with the upper portion and the base portion. The upper portion of the main support frame 11 includes a hanger bracket 111 which is a steering wheel in shape, a first post 112, a second post 113, and a third post 114. In the present embodiment, the elastic member may be a coil spring 115, and the base portion includes a sleeve 116 and a base 118 connected with the sleeve 116. The hanger bracket 111 has a perpendicular axis 1112 disposed at an end thereof. The first post 112 defines a counterbore 1124 at a top end thereof, and has an insert portion 1126 at a bottom end thereof. Similarly, the second post 113 defines a counterbore 1134 at a top end thereof, and has an insert portion 1136 at a bottom end thereof. A top end of the third post 114 defines a counterbore 1144 therein, and a bottom end of the third post 114 is fixedly connected with one end of the coil spring 115. The other end of the coil spring 115 is securely connected to the sleeve 116. The base 118 is a steering wheel in shape, and has an upright axis 1182 thereon. In assembly of the main support frame 11, at first, the perpendicular axis 1112 is tightly inserted in the counterbore 1124 of the first post 112. In sequence, the insert portion 1126 of the first post 112 is tightly inserted in the counterbore 1134 of the second post 113, and the insert portion 1136 of the second post 113 is tightly inserted in the counterbore 1144 of the third post 114, and a bottom end of the third post 114 is fixedly connected with one end of the coil spring 115. Finally, the sleeve 116 is fixedly disposed around the upright axis 1182 of the base 118. The main support frame 11 is thus mounted. Understandably, the first post 112 may be connected to the second post 113 via a threaded connection. That is, the insert portion 1126 of the first post 112 may be changed to a threaded post, and the counterbore 1134 of the second post 113 is changed to a screw hole. The threaded post is threadedly screwed in the screw hole so that the first post 112 is securely connected with the second post 113. As such, the hanger bracket 111 may be connected to the first post 112 via a threaded connection. The second post 113 may be connected to the third post 114 via a threaded connection. The sleeve 116 may be fixedly connected to the upright axis 1182 of the base 118 via a threaded connection. In addition, the first post 112, the second post 113 and the third post 114 are obviously integrated as an elongated post.

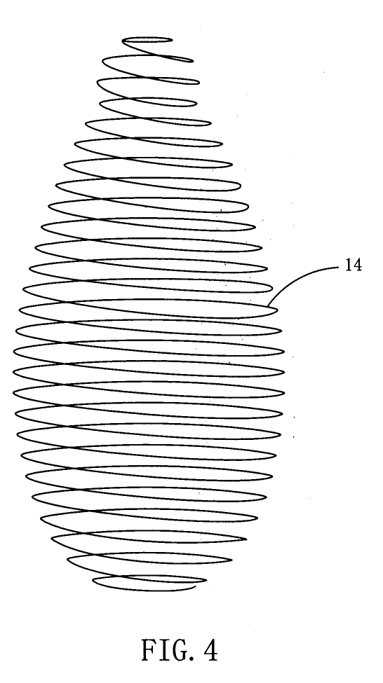

Referring to FIGS. 1 and 4, the sub-frame 14 is made of an elastic material such as a coiled, helically shaped wire or plastic. A diameter of a top end and a bottom end of the sub-frame 14 are less than that of a middle portion of the sub-frame 14. The top end of the sub-frame 14 is detachably secured to the hanger bracket 111 of the main support frame 11. The whole sub-frame 14 encircles around the first, second and third posts 112, 113, 114, and the bottom end of the sub-frame 14 is suspended in the air. In storage of the sub-frame 14, the sub-frame 14 can be retracted by compression.

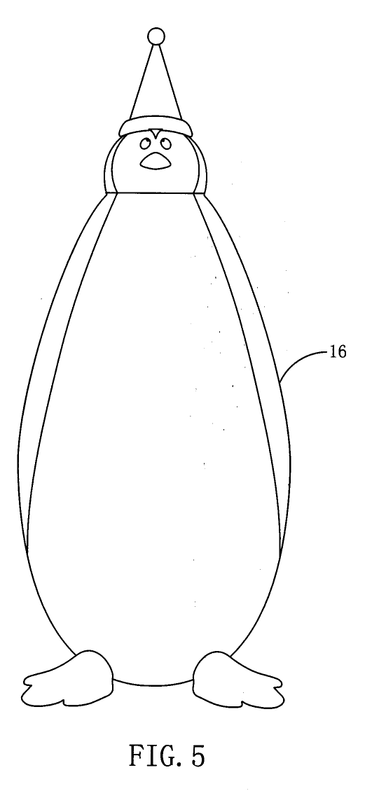

Referring to FIGS. 1 and 5, the decorative outer coating 16 is a penguin in shape in the present embodiment. The decorative outer coating 16 is attachably disposed around the sub-frame 14 so that the sub-frame 14 and the upper end of the main support frame 11 are covered. The decorative outer coating 16 is made of a soft and transparent/translucent material, for example, a PVC (Polyvinyl Chloride) film, or cloth and so on. An outer surface of the decorative outer coating 16 may have different patterns according to requirement. Understandably, the decorative outer coating 16 may be a snowman or a Santa Claus in shape for matching the shape of the sub-frame 14.

In the above embodiments, when a breeze blows on the detachable decorative light assembly 10, the detachable decorative light assembly 10 swings from side to side due to the coil spring 115. Further, a dynamic effect may be produced for the detachable decorative light assembly 10 as a result of interspersion of the LED light strands 12 which are switched on.

In disassembly of the detachable decorative light assembly 10, the decorative outer coating 16 is first removed. The sub-frame 14 is then disengaged from the upper portion of the main support frame 11. The sub-frame 14 can be compressed in order to save storage room. Sequently, the light strand 12 is taken down from the main support frame 11. Finally, the main support frame 11 is easily detached by pulling out the hanger bracket 111 and the base 118. Thus, the detachable decorative light assembly 10 can be easily disassembled for convenient storage and shipment.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the present invention.

What is claimed is:

1. A detachable decorative light assembly comprising:
at least one light strand;
a main support frame configured for suspending the at least one light strand thereon, the main support frame comprising an upper portion, a base portion, and an elastic member connected with the upper portion and the base portion;
a sub-frame positioned on the main support frame and disposed around the upper portion of the main support frame and the at least one light strand; and
a decorative outer coating configured for covering the sub-frame and the upper portion of the main support frame thereon, wherein the decorative outer coating and the sub-frame swing from side to side together with the upper portion of the main support frame when force is exerted on the detachable decorative light assembly.

2. The detachable decorative light assembly as described in claim 1, wherein the upper portion of the main support frame comprises a hanger bracket, a first post, a second post and a third post, and the hanger bracket, the first post, the second post, and the third post are detachably connected in sequence.

3. The detachable decorative light assembly as described in claim 2, wherein the base portion of the main support frame comprises a sleeve and a base connected to the sleeve, and the elastic member is securely connected with the third post and the sleeve.

4. The detachable decorative light assembly as described in claim 3, wherein the elastic member is a coil spring.

5. The detachable decorative light assembly as described in claim 2, wherein the sub-frame is made of an elastic material, and a top end of the sub-frame is detachably secured to the hanger bracket of the main support frame.

6. The detachable decorative light assembly as described in claim 5, wherein the whole sub-frame encircles the first, second and third posts.

7. A decorative light assembly comprising:
at least one light strand;
a main support frame configured for suspending the at least one light strand thereon, the main support frame comprising an upper portion, a base portion, and an elastic member connected with the upper portion and the base portion, wherein the upper portion of the main support frame swings from side to side relative to the base portion when force is exerted on the upper portion of the main support frame;
a sub-frame disposed around the upper portion of the main support frame and the at least one light strand, a top end of the sub-frame detachably connected to the upper portion of the main support frame; and
a decorative outer coating configured for covering the sub-frame and the upper portion of the main support frame thereon.

8. The decorative light assembly as described in claim 7, wherein the upper portion of the main support frame comprises a hanger bracket, a first post, a second post, and a third post, and the hanger bracket, the first post, the second post, and the third post are detachably connected in sequence.

9. The decorative light assembly as described in claim 8, wherein the base portion of the main support frame comprises a sleeve and a base connected to the sleeve, and the elastic member securely connected with the third post and the sleeve.

10. The decorative light assembly as described in claim 9, wherein the elastic member is a coil spring.

11. The decorative light assembly as described in claim 8, wherein the sub-frame is made of elastic material, and the top end of the sub-frame is detachably secured to the hanger bracket of the main support frame.

12. The decorative light assembly as described in claim 11, wherein the sub-frame encircles the first, second and third posts.

13. The decorative light assembly as described in claim 7, wherein the decorative outer coating is made of a soft material.

14. The decorative light assembly as described in claim 13, wherein the decorative outer coating is made of a PVC film.
